(19) United States
(12) Patent Application Publication
(10) Pub. No.: US 2025/0264875 A1
(43) Pub. Date: Aug. 21, 2025

(54) SYSTEM AUGMENTING PERCEPTION AND CONTROL FOR A REMOTE OPERATIVE VEHICLE USING SURROUNDING CONNECTED VEHICLES

(71) Applicant: TOYOTA MOTOR ENGINEERING & MANUFACTURING NORTH AMERICA, INC., Plano, TX (US)

(72) Inventors: SERGEI S. AVEDISOV, Mountain View, CA (US); Onur Altintas, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, TOYOTA-SHI (JP)

(21) Appl. No.: 18/583,470

(22) Filed: Feb. 21, 2024

(51) Int. Cl. G05D 1/222; G05D 1/617; G05D 1/69; G05D 109/10; G05D 111/30; H04W 4/46

(52) U.S. Cl. CPC G05D 1/222; G05D 1/617; G05D 1/69; H04W 4/46; G05D 2109/10; G05D 2111/30

(57) ABSTRACT

Systems and methods are provided for augmenting a sensor view of a vehicle. The system can determine that the vehicle needs operation assistance to complete a remote driving task. Sensor information can be requested from the vehicle. Based on the sensor information, the system can determine that the sensor information is insufficient to perform the remote driving task. The system can connect with one or more surrounding vehicles connected to the vehicle to obtain supplemental sensor information. The sensor information and the supplemental sensor information can be applied to complete the remote driving task.

### TECHNICAL FIELD

The present disclosure relates generally to remote controlled driving, and in particular, some implementations may relate to the vehicle's interpretation of its environment to facilitate remote controlled driving.

### DESCRIPTION OF RELATED ART

Remote driving occurs when commands to the throttle, brake, and steering are prescribed by an operator not located inside the vehicle. These commands can be relayed through wireless communication. Remote driving can serve as a fallback option for the safety of vehicle occupants. Remote driving can be used in various situations to act as a professional driver overriding the driver inside the vehicle. For instance, remote driving can be applied: when a driver intoxicated, unconscious, or incapacitated, when the vehicle is severely damaged, or when the vehicle/driver is in other distress. In testing environments, remote driving can be helpful to run crash tests without endangering any human lives. BRIEF SUMMARY OF THE DISCLOSURE

According to various embodiments of the disclosed technology, a method can comprise determining that the vehicle needs operation assistance to complete a remote driving task; requesting sensor information from the vehicle; based on the sensor information, determining that the sensor information is insufficient to perform the remote driving task; connecting with one or more surrounding vehicles connected to the vehicle; obtaining supplemental sensor information from the one or more surrounding vehicles; and applying the sensor information of the vehicle and the supplemental sensor information to complete the remote driving task.

In some embodiments, the method further comprises determining what sensor information is needed to perform the remote driving task; and requesting the needed sensor information from the one or more surrounding vehicles.

In some embodiments, applying the sensor information of the vehicle and the supplemental sensor information comprises generating a world view of an environment of the vehicle.

In some embodiments, the sensor information of the vehicle and the supplemental sensor information is received at a remote operator station configured to simulate an environment of the vehicle.

In some embodiments, the method further comprises determining what sensor information is needed to perform the remote driving task; and directing the one or more surrounding vehicles into a position where the supplemental sensor information can be generated.

In some embodiments, the remote driving task comprises a safety operation.

In some embodiments, completing the remote driving task comprises taking remote control of the vehicle from a remote operator station and executing the remote driving task.

In some embodiments, the method further comprises receiving a request from the vehicle for operation assistance.

In some embodiments, connecting with the one or more surrounding vehicles connected to the vehicle comprises communicating cooperative maneuvers for the one or more surrounding vehicles to perform to obtain the supplemental sensor information.

In some embodiments, the one or more surrounding vehicles connected to the vehicle relay maneuver-related messages to the vehicle to obtain the sensor information.

According to various embodiments of the disclosed technology, a system for augmenting a sensor view of a vehicle can comprise a processor and a memory coupled to the processor to store instructions, which when executed by the processor, causes the processor to determine that the vehicle needs operation assistance to complete a remote driving task; request sensor information from the vehicle; based on the sensor information, determine that the sensor information is insufficient to perform the remote driving task; direct one or more surrounding vehicles in a position to generate supplemental sensor information; obtain the supplemental sensor information from the one or more surrounding vehicles; and apply the sensor information of the vehicle and the supplemental sensor information to complete the remote driving task.

In some embodiments, the instructions further cause the processor to determine what sensor information is needed to perform the remote driving task; and request the needed sensor information from the one or more surrounding vehicles.

In some embodiments, the instructions further cause the processor to generate a world view of an environment of the vehicle.

In some embodiments, the remote driving task comprises a safety operation.

In some embodiments, the instructions further cause the processor to take remote control of the vehicle from a remote operator station and execute the remote driving task.

In some embodiments, the instructions further cause the processor to receive a request from the vehicle for operation assistance.

According to various embodiments of the disclosed technology, a non-transitory machine-readable medium can have instructions stored therein, which when executed by a processor, causes the processor to: determine that a vehicle needs operation assistance to complete a remote driving task; request sensor information from the vehicle; based on the sensor information, determine that the sensor information is insufficient to perform the remote driving task; connect with one or more surrounding vehicles connected to the vehicle; obtain supplemental sensor information from the one or more surrounding vehicles; take remote control of the vehicle; and execute the remote driving task based on the sensor information and the supplemental sensor information.

In some embodiments, the instructions further cause the processor to determine what sensor information is needed to perform the remote driving task and request the needed sensor information from the one or more surrounding vehicles.

In some embodiments, the instructions further cause the processor to generate a world view of an environment of the vehicle.

In some embodiments, the instructions further cause the processor to determine what sensor information is needed to perform the remote driving task and direct the one or more surrounding vehicles into a position where the supplemental sensor information can be generated.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for augmenting a vehicle's sensor view in accordance with one embodiment of the systems and methods described herein.

FIG. 3A illustrates an example system for augmenting a vehicle's sensor view in accordance with various embodiments.

FIG. 3B illustrates an example system for an ego vehicle in accordance with various embodiments.

FIG. 3C illustrates an example system for a remote operator station in accordance with various embodiments.

FIG. 3D illustrates an example system for surrounding connected vehicles in accordance with various embodiments.

FIG. 4A illustrates an example scenario where a vehicle can request sensor assistance, in accordance with one embodiment.

FIG. 4B illustrates an example scenario where surrounding vehicles can augment a vehicle's sensor view, in accordance with one embodiment.

FIG. 5 illustrates an example method for augmenting a vehicle's sensor view in accordance with one embodiment.

FIG. 6 is an example computing component that may be used to implement various features of embodiments described in the present disclosure.

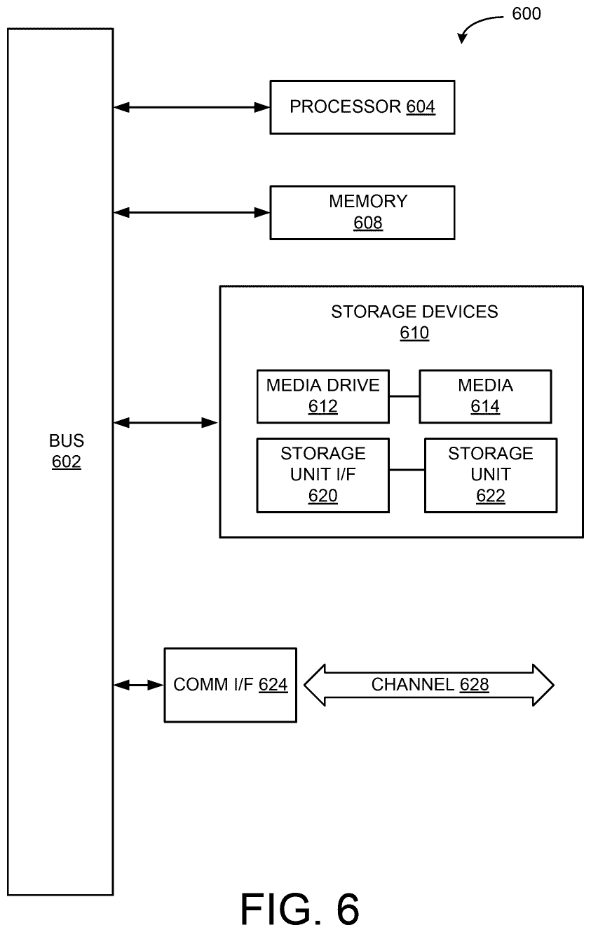

The figures are not exhaustive and do not limit the present disclosure to the precise form disclosed.

### DETAILED DESCRIPTION

Remote driving can be used in various situations to act as a professional driver overriding or substituting for the driver inside the vehicle. Remote driving can be effectuated by a human operator located away from the “ego vehicle” (remote controlled vehicle) and/or by an automated remote driver. To accomplish remote driving, the remote operator needs to have a good understanding of the ego vehicle's environment and driving situation, which in some situations can be established by using the ego vehicle's sensor data to determine a world view of the ego vehicle. For example, motion sensors can determine the number, location, and speed of other vehicles surrounding the ego vehicle. Environmental data can determine time of day, weather conditions, and upcoming hazards. Internal sensors can monitor the ego vehicle's operating condition and maintenance needs. Just like a driver inside of a vehicle, a remote operator can use this sensor information to determine the optimal way to operate the ego vehicle. However, in some scenarios the ego vehicle may not have all of its sensors functioning to establish the proper world view. This may occur due to internal malfunctioning or other operating condition. For instance, certain sensors may not be accurate during nighttime due to the lack of available light. In these situations, the remote operator would not receive enough information about the ego vehicle's environment to remotely operate the ego vehicle. In situations where the driver inside the vehicle is incapacitated, this could greatly endanger the lives of the driver or drivers in surrounding vehicles.

Embodiments of the systems and methods disclosed herein can “augment” the ego vehicle's sensor worldview so that a remote operator can properly operate the vehicle. In particular, this system can use data from surrounding connected vehicles (SCVS) to detect that the ego vehicle needs sensory augmentation and provide that sensor augmentation to the remote operator. SCVS may have additional sensor data that the ego vehicle does not have access to or cannot access at the time. SCVS can transmit this sensor data to a remote database while the ego vehicle transmits the sensor data available to the ego vehicle. All data can be aggregated to form the world view necessary for the remote operator. The remote operator can then engage remote control of the vehicle and execute any needed safety or other driving maneuvers. Once the remote operator has completed the remote driving task, SCVS can stop sharing sensor data and the ego vehicle can return to normal operation.

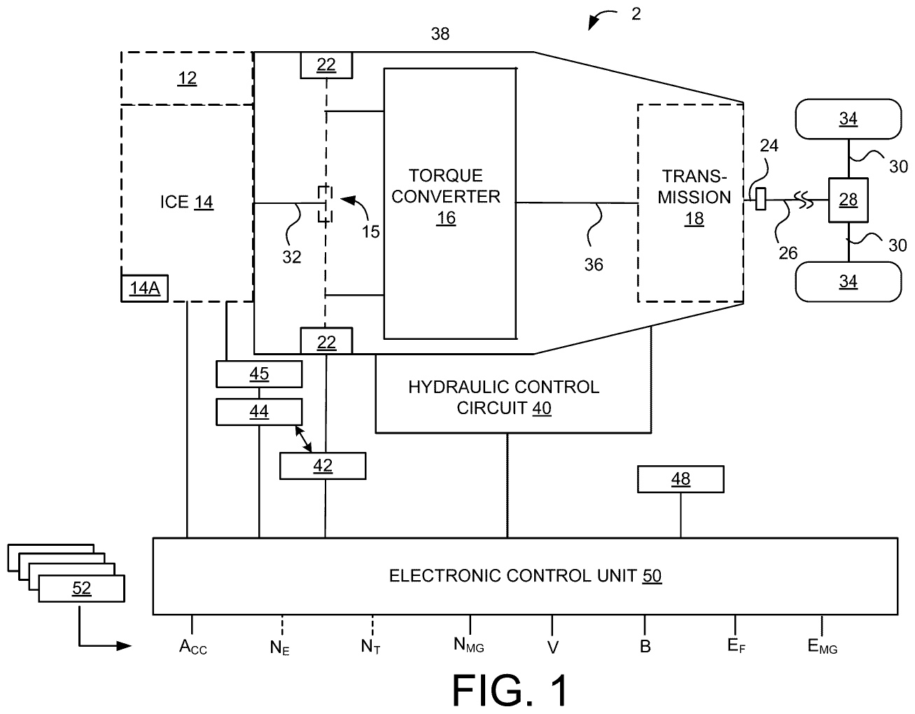

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for augmenting the vehicle's sensor view can be implemented in other types of vehicle including gasoline-or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{f}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

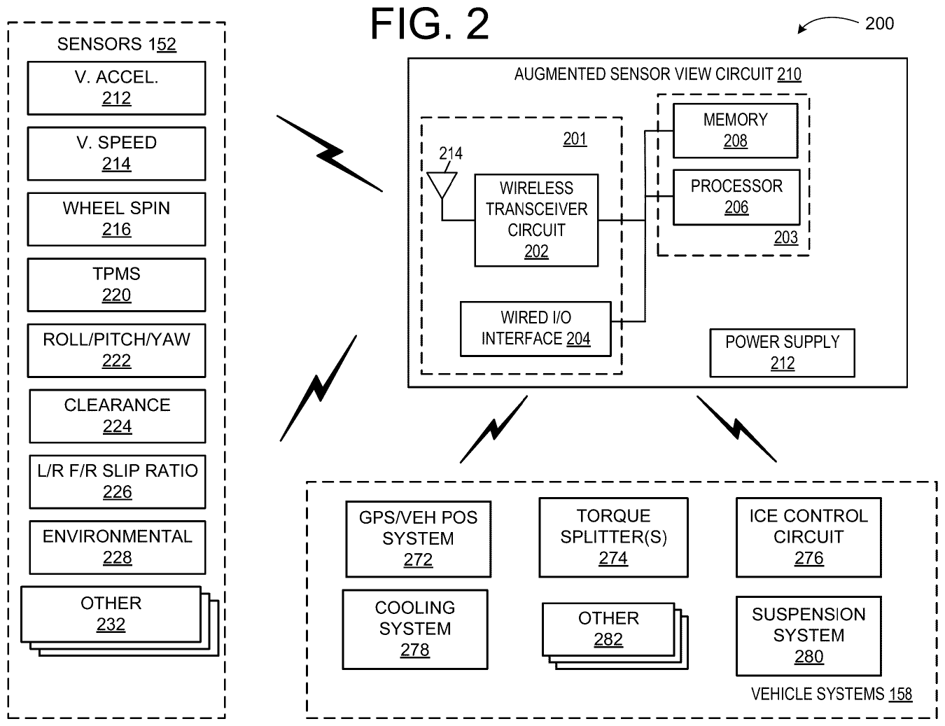

FIG. 2 illustrates an example architecture for augmenting a vehicle's sensor view in accordance with one embodiment of the systems and methods described herein. Referring now to FIG. 2, in this example, augmented sensor view system 200 includes an augmented sensor view circuit 210, a plurality of sensors 152 and a plurality of vehicle systems 158. Sensors 152 and vehicle systems 158 can communicate with augmented sensor view circuit 210 via a wired or wireless communication interface. Although sensors 152 and vehicle systems 158 are depicted as communicating with augmented sensor view circuit 210, they can also communicate with each other as well as with other vehicle systems. Augmented sensor view circuit 210 can be implemented as an ECU or as part of an ECU such as, for example electronic control unit 50. In other embodiments, augmented sensor view circuit 210 can be implemented independently of the ECU.

Augmented sensor view circuit 210 in this example includes a communication circuit 201, a decision circuit 203 (including a processor 206 and memory 208 in this example) and a power supply 212. Components of augmented sensor view circuit 210 are illustrated as communicating with each other via a data bus, although other communication in interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to augmented sensor view circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up augmented sensor view circuit 210.

Communication circuit 201 includes either or both a wireless transceiver circuit 202 with an associated antenna 205 and a wired I/O interface 204 with an associated hardwired data port (not illustrated). Communication circuit 201 can provide for V2X and/or V2V communications capabilities, allowing local augmented sensor view circuit 210 to communicate with edge devices, such as roadside unit/equipment (RSU/RSE), network cloud servers and cloud-based databases, and/or other vehicles via a network. For example, V2X communication capabilities allows surprise detection circuit 210 to communicate with edge/cloud devices, roadside infrastructure (e.g., such as roadside equipment/roadside unit, which may be a vehicle-to-infrastructure (V2I)-enabled streetlight or cameras, for example), etc. Augmented sensor view circuit 210 may also communicate with other connected vehicles over vehicle-to-vehicle (V2V) communications. For example, current driving conditions/environment data may include data relayed to the ego vehicle from, e.g., an RSE (instead of from an on-board sensor, such as sensors 252), which can then be relayed to the augmented sensor view server.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with augmented sensor view circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by augmented sensor view circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which augmented sensor view system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of augmented sensor view system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

During operation, augmented sensor view circuit 210 can receive information from various vehicle sensors to determine whether the vehicle requires an augmented sensor view. Communication circuit 201 can be used to transmit and receive information between augmented sensor view circuit 210 and sensors 152, and augmented sensor view circuit 210 and vehicle systems 158. Also, sensors 152 may communicate with vehicle systems 158 directly or indirectly (e.g., via communication circuit 201 or otherwise).

In various embodiments, augmented sensor view circuit 210 can be configured to receive data and other information from sensors 152 that is used in determining whether to augment the vehicle's sensor view. Additionally, augmented sensor view circuit 210 can be used to send an activation signal or other activation information to various vehicle systems 158 as part of augmenting the sensor view. For example, as described in more detail below, augmented sensor view circuit 210 can be used to send signals to one or more of: torque splitters 274 to control front/rear torque split and left/right torque split; motor controllers 276 to, for example, control motor torque, motor speed of the various motors in the system; ICE control circuit 276 to, for example, control power to engine 14 (e.g., to shut down the engine so all power goes to the rear motors, to ensure the engine is running to charge the batteries or allow more power to flow to the motors); cooling system (e.g., 278 to increase cooling system flow for one or more motors and their associated electronics); suspension system 280 (e.g., to increase ground clearance such as by increasing the ride height using the air suspension). The decision regarding what action to take via these various vehicle systems 158 can be made based on the information detected by sensors 152. Examples of this are described in more detail below.

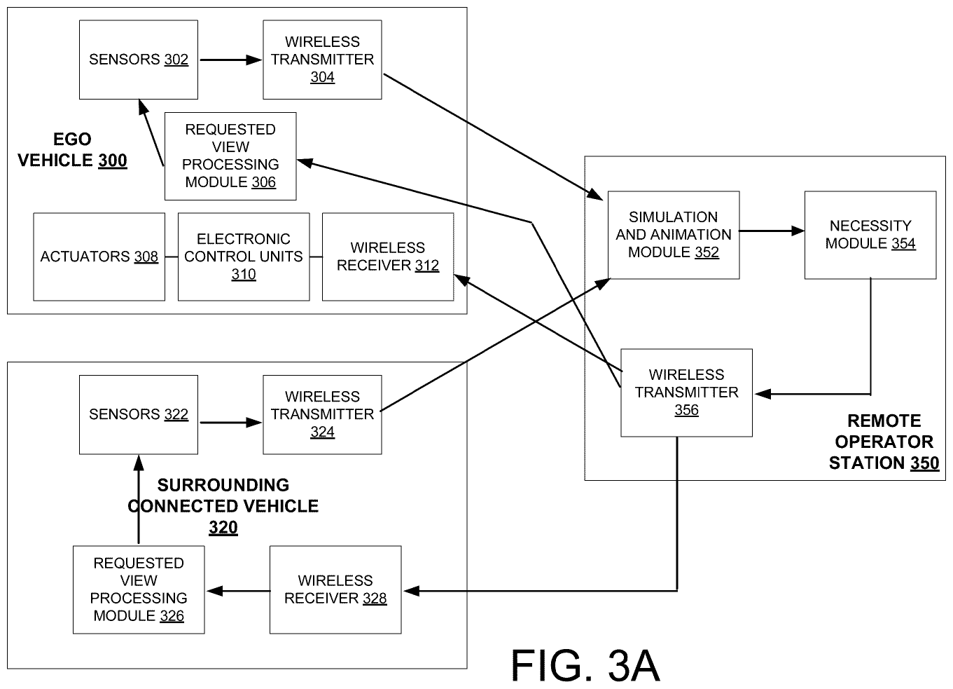

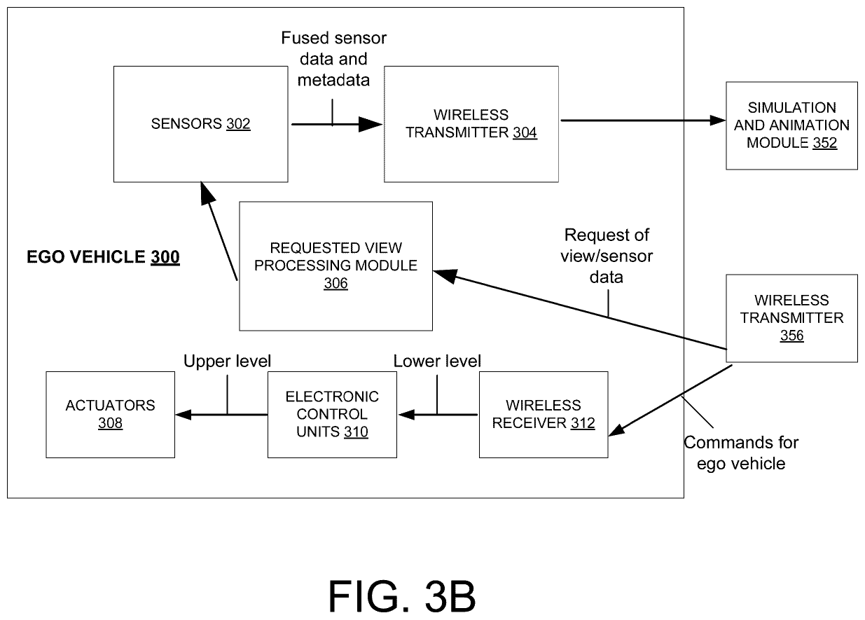

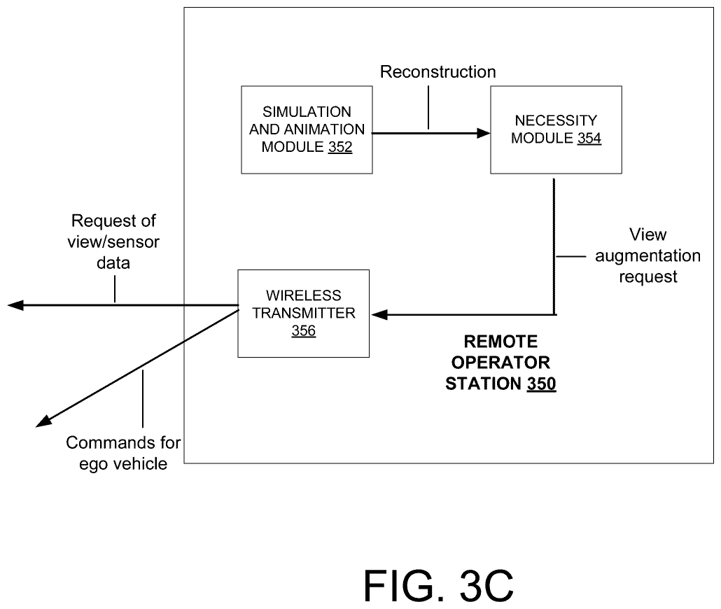

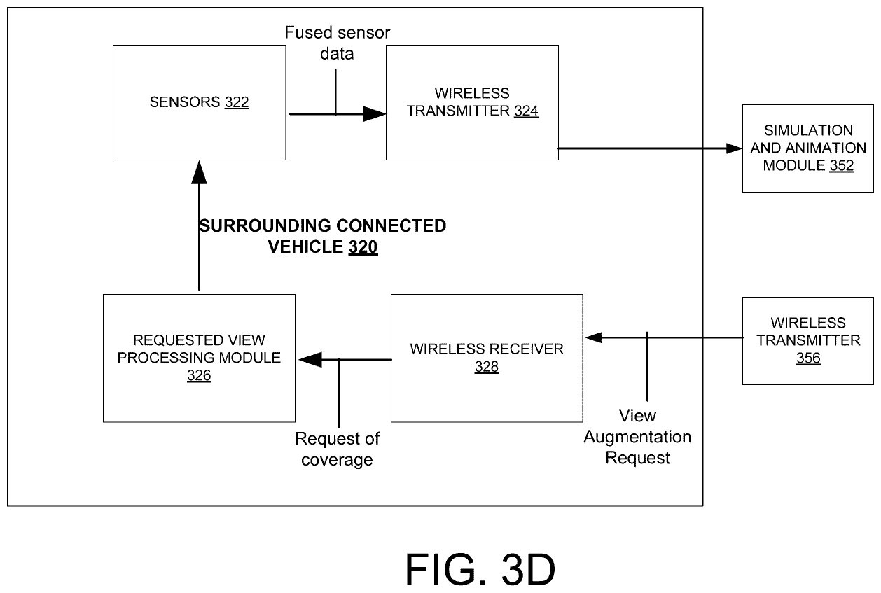

FIGS. 3A-3D illustrate an example system for augmenting an ego vehicle's world view. Turning to FIGS. 3A and 3B, ego vehicle 300 may comprise sensors 302, wireless transmitter 304, requested view processing module 306, actuators 308, electronic control units 310, and wireless receiver 312. As described above in FIG. 2, sensors 302 can comprise any sensors to generate a view of the ego vehicle's environment (e.g., sensors 152, motion sensors, video or audio cameras, or any other available sensor). Sensors 302 can send fused sensor data and corresponding metadata to wireless transmitter 304. Wireless transmitter 304 can transmit the fused sensor data and metadata to remote operator station 350, described further below with reference to FIG. 3C. Wireless transmitter 304 and wireless receiver 312 can correspond to wireless transceiver circuit 202 as described above in FIG. 2. Remote operator station 350 can transmit a request for the ego vehicle's world view through the available sensor data. This request can be received at requested view processing module 306, which can determine that sensor data needs to be transmitted to remote operator station 350. Requested view processing module 306 can forward this request to sensors 302, which in turn can transmit fused sensor data and metadata to wireless transmitter 304. Wireless transmitter 304 can forward this data to remote operator station 350 in response to the request for sensor data.

Once remote operator station 350 has established a sufficient world view, remote operator station 350 can transmit driving commands to be received at wireless receiver 312. Wireless receiver 312 can forward these commands to electronic control units 310. Electronic control units 310 can be any vehicle electronic control unit (e.g., electronic control unit 50 of FIG. 1) able to receive lower driving commands and designate upper driving commands to actuators 308. Here, lower driving commands can refer to throttle position, brake pedal position, steering angle, engine fuel rate. Upper driving commands can refer to a trajectory prescribed to the teleoperated vehicle. Actuators 308 and electronic control units 310 can execute the driving commands as dictated by the remote operator station to complete the remote driving task.

Turning to FIGS. 3A and 3D, SCV 320 can comprise sensors 322, wireless transmitter 324, requested view processing module 326, and wireless receiver 328. Sensors 322 can comprise similar sensor data to that of sensors 302; however, sensors 322 can incorporate additional sensor data deemed to be missing from the ego vehicle's world view. As with sensors 302, sensors 322 can transmit fused sensor data and metadata to wireless transmitter 324, which can transmit the sensor data to remote operator station 350. As described further below with reference to FIGS. 3C, 4, and 5, remote operator station 350 can transmit a request for augmented sensor data to SCV 320. This request can be received at wireless transmitter 328, which can forward the request to requested view processing module 326. Requested view processing module 326 can be similar to requested view processing module 306; however, the augmentation request can include requests for sensor data outside of that available to ego vehicle 300. This request can be forwarded to sensors 322 to be transmitted to remote operator station 350.

Turning to FIGS. 3A and 3C, remote operator station 350 can be any remote operator station including automated facilities and/or live human operators. Remote operator station 350 can be located anywhere to achieve wide access to various ego vehicles and corresponding SCVS. Remote operator station 350 can include simulation and animation module 352, necessity module 354, and wireless transmitter 356. Simulation and animation module 352 can receive sensor data from sensors 302 and sensors 322 to generate the augmented world view. First, simulation and animation module 352 can receive sensor data from sensors 302. Simulation and animation module 352 can generate a partial worldview from solely the ego vehicle's sensor data. At necessity module 304, remote operator station 350 can determine that the partial worldview is incomplete due to insufficient sensor data. Necessity module 304 can determine what sensor data is needed to complete the world view. Necessity module 304 can then generate an augmentation request to be forwarded to SCV 320. Wireless transmitter 356 can forward this request. As described above, once SCV 320 receives the augmentation request, SCV 320 can provide the appropriate sensor data to simulation and animation module 352. Simulation and animation module 352 can complete the sensor world view with the aggregated sensor data. Once the world view is complete, necessity module 354 can determine that no additional sensor data is necessary. Remote operator station 350 can then transmit driving commands via wireless transmitter 356 back to ego vehicle 300 to complete the remote driving task. Alternatively, if the world view is still incomplete, necessity module 304 can generate additional augmentation requests to be forwarded to additional SCVS as is necessary to complete the world view. Remote operator station 350 can continue evaluating the sensor world view until remote driving is accessible.

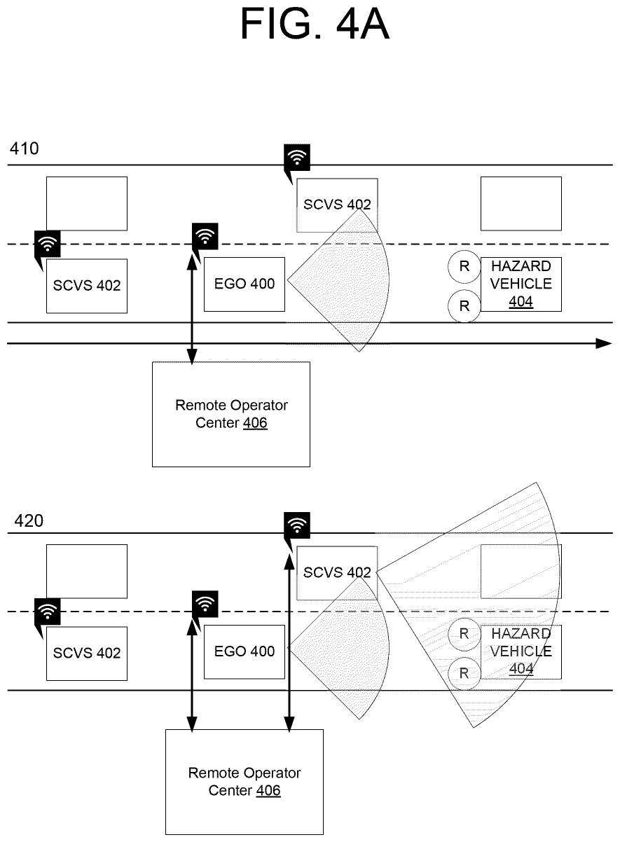

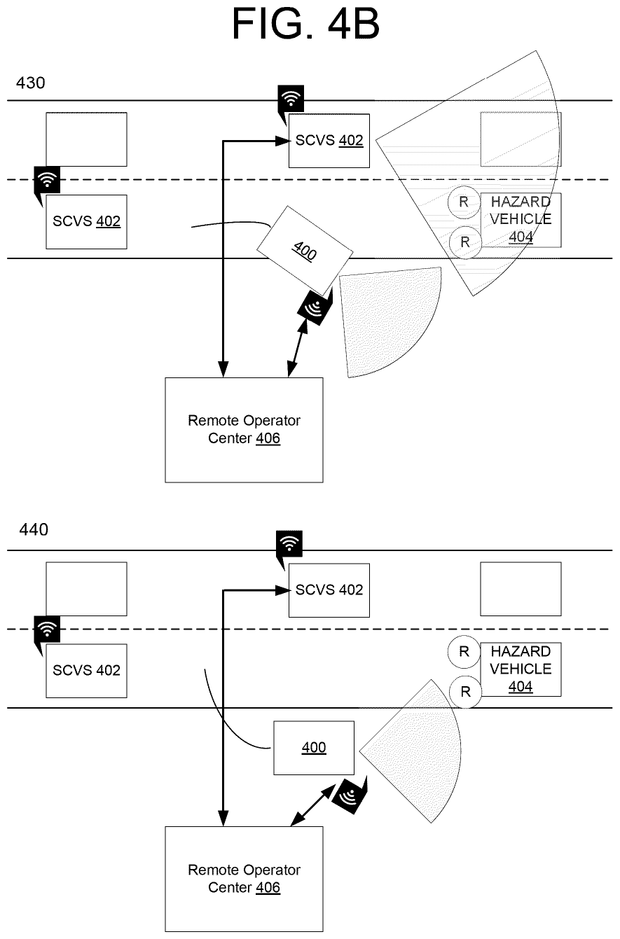

FIGS. 4A and 4B illustrate an example driving scenario where an augmented sensor view can be generated and applied. Referring to FIG. 4A, step 410, ego vehicle 400 may be driving on a two-lane highway. Ego vehicle 400 may be any connected automated vehicle that can communicate with remote operator station 406. Illustrated on this highway are SCVS 402 that can communicate with remote operator station 406, and several unconnected vehicles. At step 410, ego vehicle 400 may send a “SOS” signal to remote operator station 406, requesting assistance in remote operation. As mentioned above, this assistance can be requested in various situations, such as when the ego driver is incapacitated, or the driver/vehicle is in other distress. As described above, the remote operator can determine the emergency scenario and the needed sensor data to complete the remote driving task. Remote operator center 406 can communicate the proposed remote driving task to ego vehicle 400, which can accept the request for remote control. In this case, ego vehicle 400 may be approaching hazard vehicle 404, which may be braking or stopped in the highway, indicated by red taillights.

In the example of step 410, the system may require a short-range radar, long-range radar, and one or more cameras in order to produce a minimum risk maneuver in response to hazard vehicle 404, such as pulling over to the shoulder, slowing down the vehicle, and/or effectuating a lane change. As described above in FIGS. 3A-3D, the remote operator center can access ego vehicle 400′s short-range radar and cameras. Remote operator center 406 can determine that the ego vehicle does not have long-range radar accessible to complete the world view. At step 420, the remote operator can transmit the augmentation request to SCVS 402. As illustrated at step 420, one of the SCVS has access to long-range radar. Remote operator center 406 can send a request for the long-range radar data stream. In some embodiments, remote operator center 406 can request an assisting maneuver from the SCVS so that they augment the data until ego vehicle 400 slows down sufficiently not to need the sensor augmentation. An assisting maneuver can include moving the SCV into a good location such that the SCV's sensor data corresponds to the ego vehicle's world view. Once the SCVS accept the request for sensor data and the request for the assisting maneuver, SCVS 402 can communicate the additional sensor data to remote operator center 406 to complete the world view. Concurrently, ego vehicle 400 can begin transmitting its short-range radar data and camera streams.

Referring to FIG. 4B, at step 430, remote operator center 406 can initiate remote control of ego vehicle 400 by sending commands and getting a stream of sensor data from ego vehicle 400. Optionally, remote operator center 406 can send maneuver messages to SCVS 402 to be positioned in a way that best augments the ego vehicle's sensors. Here, maneuver messages can refer to the general class of wireless messages exchanged among road users, and between road users and infrastructure. Each message can contain the future trajectory (or possible future trajectories) of the transmitting road user. Specific examples of such messages are the Maneuver Coordination Message (MCM) and the Maneuver Sharing Coordination Message (MSCM). Remote operator center 406 can request maneuvers from SCVS 402 based on the automation capabilities of SCVS 402 and the acceptance of the maneuver requests.

At step 440, remote operator center 406 can successfully guide ego vehicle 400 onto the shoulder of the road. Remote operator center 406 can send a “remote operation finished notification” to both ego vehicle 400 and SCVS 402. In some embodiments, remote operator center 406 can determine that it does not require additional assistance from SCVS 402 and release the vehicles from automated driving. SCVS 402 can stop streaming sensor data to the remote operator and can stop allowing for assisting maneuvers.

The scenario described in FIGS. 4A and 4B can be altered depending on the emergency and/or capabilities of the surrounding vehicles and environment. For example, in some embodiments, ego vehicle 400 may not reliably communicate with remote operator center 406 but can only send an SOS signal, alerting that it requires assistance. This could be due to the fact that its data communication module (cellular modem) is malfunctioning. In this case, remote operator center 406 can send maneuver messages (MM) to ego vehicle 400, i.e., via a roadside unit that can communicate with the ego vehicle via standardized V2V communication. As the suggested maneuver is executed, the roadside unit can continue to send maneuver messages. The ego vehicle can continue to confirm its ability to perform the maneuver via response maneuver messages. When ego vehicle 400 finishes the requested maneuver, it can send a status message saying that the remote operation is finished.

In some embodiments, remote operator center 406 may not have an available roadside unit, so it cannot relay the maneuver message directly to ego vehicle 400 with the suggested maneuvering. In this case, remote operator center 406 can send a control message to SCVS 402 to be relayed to ego vehicle 400. For instance, when remote operator center 406 communicates with ego vehicle 400, vehicle may traditionally accept remote control by means of a message, start streaming sensor information, or may follow commands given by remote operator center 406. If there is sufficient delay before ego vehicle 400 executes any of the above, remote operator center 406 may engage in “cooperative maneuvering mode.” After determining that the only way to control ego vehicle 400 is through controlling SCVS 402, remote operator center 406 can send a request to control SCVS 402. If SCVS 402 are automated, these vehicles can cooperate with ego vehicle 400 in the subsequent maneuver. If neither SCV is automated, these vehicles can relay specific commands sent by the remote operator or relay the entire suggested minimal risk maneuver by a complete trajectory. Relaying specific commands instead of the entire trajectory may be beneficial in certain situations. For example, specific commands may allow for finer specification of ego vehicle 400′s minimal risk maneuver. However, in some situations, the latency in transmitting multiple specific commands separately may be high, as a large amount of data may need to be relayed from remote operator center 406. Once the maneuver is finished, ego vehicle 400 can send a notification that the remote operation is finished. The message can be sent first to SCVS 402 and then relayed to remote operator center 406. As described in FIGS. 4A and 4B, remote operator center 406 can release SCVS 402 and stop accepting the additional sensory data.

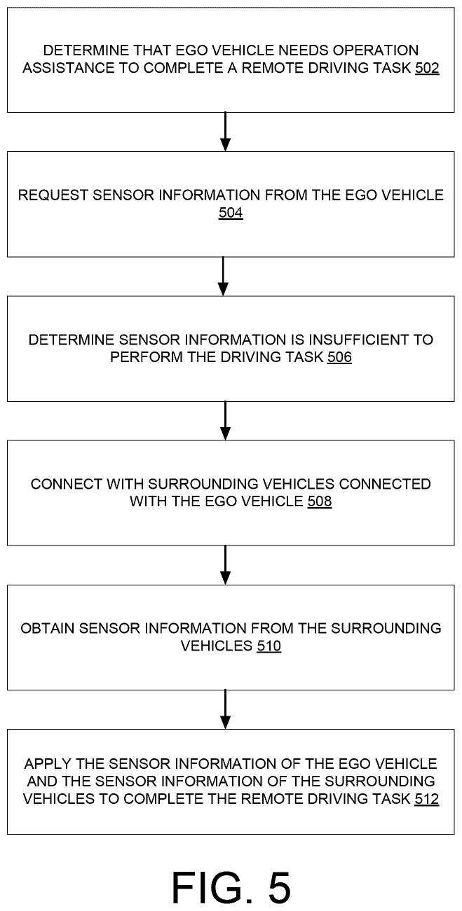

FIG. 5 illustrates an example method in accordance with the systems described above. At block 502, the system can determine that the vehicle needs operation assistance to complete a remote driving task. As described above, the ego vehicle may send a “SOS” signal to a remote operator station, requesting assistance in remote operation. This assistance can be requested in various situations, such as when the ego driver is incapacitated, or the driver/vehicle is in other distress. As described above, the remote operator can determine the emergency scenario and the needed sensor data to complete the remote driving task.

At block 504, the system can request sensor data from the ego vehicle. As described above, sensor data can include any sensors needed to generate a view of the ego vehicle's environment (e.g., sensors 152, motion sensors, video or audio cameras, or any other available sensor). Fused sensor data and corresponding metadata can be transmitted to generate the sensor worldview.

At block 506, the system can determine the sensor information is insufficient to complete the driving task. As described above, a simulation and animation module can generate a partial worldview from solely the ego vehicle's sensor data. A necessity module can determine that the partial worldview is incomplete due to insufficient sensor data. This necessity module can determine what sensor data is needed to complete the world view. The necessity module can then generate an augmentation request to be forwarded to surrounding connected vehicles.

At blocks 508 and 510, the system can connect with surrounding vehicles connected with the ego vehicle (SCVS) and obtain sensor information from the SCVS. As described above, once an SCV receives the augmentation request, the SCV can provide the appropriate sensor data to the simulation and animation module. A simulation and animation module can complete the sensor world view with the aggregated sensor data. Once the world view is complete, the necessity module can determine that no additional sensor data is necessary. Alternatively, if the world view is still incomplete, the necessity module can generate additional augmentation requests to be forwarded to additional SCVS as is necessary to complete the world view. The sensor world view can be continuously evaluated until remote driving is accessible. At block 512, the system can apply the sensor information of the ego vehicle and the sensor information of the surrounding vehicles to complete the remote driving task.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 600. After reading this description, it will become apparent to a person skilled in the relevant art how to implement the application using other computing components or architectures.

Referring now to FIG. 5, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for augmenting a sensor view of a vehicle, comprising:
determining that the vehicle needs operation assistance to complete a remote driving task;
requesting sensor information from the vehicle;
based on the sensor information, determining that the sensor information is insufficient to perform the remote driving task;
connecting with one or more surrounding vehicles connected to the vehicle;
obtaining supplemental sensor information from the one or more surrounding vehicles; and
applying the sensor information of the vehicle and the supplemental sensor information to complete the remote driving task.

2. The method of claim 1, further comprising:
determining what sensor information is needed to perform the remote driving task; and
requesting the needed sensor information from the one or more surrounding vehicles.

3. The method of claim 1, wherein applying the sensor information of the vehicle and the supplemental sensor information comprises generating a world view of an environment of the vehicle.

4. The method of claim 1, wherein the sensor information of the vehicle and the supplemental sensor information is received at a remote operator station configured to simulate an environment of the vehicle.

5. The method of claim 1, further comprising:
determining what sensor information is needed to perform the remote driving task; and
directing the one or more surrounding vehicles into a position where the supplemental sensor information can be generated.

6. The method of claim 1, wherein the remote driving task comprises a safety operation.

7. The method of claim 1, wherein completing the remote driving task comprises taking remote control of the vehicle from a remote operator station and executing the remote driving task.

8. The method of claim 1, further comprising receiving a request from the vehicle for operation assistance.

9. The method of claim 1, wherein connecting with the one or more surrounding vehicles connected to the vehicle comprises communicating cooperative maneuvers for the one or more surrounding vehicles to perform to obtain the supplemental sensor information.

10. The method of claim 1, wherein the one or more surrounding vehicles connected to the vehicle relay maneuver-related messages to the vehicle to obtain the sensor information.

11. A system for augmenting a sensor view of a vehicle, comprising:
a processor; and
a memory coupled to the processor to store instructions, which when executed by the processor, cause the processor to:
determine that the vehicle needs operation assistance to complete a remote driving task;
request sensor information from the vehicle;
based on the sensor information, determine that the sensor information is insufficient to perform the remote driving task;
direct one or more surrounding vehicles in a position to generate supplemental sensor information;
obtain the supplemental sensor information from the one or more surrounding vehicles; and
apply the sensor information of the vehicle and the supplemental sensor information to complete the remote driving task.

12. The system of claim 11, wherein the instructions further cause the processor to:
determine what sensor information is needed to perform the remote driving task; and
request the needed sensor information from the one or more surrounding vehicles.

13. The system of claim 11, wherein the instructions further cause the processor to generate a world view of an environment of the vehicle.

14. The system of claim 11, wherein the remote driving task comprises a safety operation.

15. The system of claim 11, wherein the instructions further cause the processor to take remote control of the vehicle from a remote operator station and execute the remote driving task.

16. The system of claim 11, wherein the instructions further cause the processor to receive a request from the vehicle for operation assistance.

17. A non-transitory machine-readable medium having instructions stored therein, which when executed by a processor, cause the processor to:
determine that a vehicle needs operation assistance to complete a remote driving task;
request sensor information from the vehicle;
based on the sensor information, determine that the sensor information is insufficient to perform the remote driving task;
connect with one or more surrounding vehicles connected to the vehicle;
obtain supplemental sensor information from the one or more surrounding vehicles;
take remote control of the vehicle; and
execute the remote driving task based on the sensor information and the supplemental sensor information.

18. The non-transitory machine-readable medium of claim 15, wherein the instructions further cause the processor to:
determine what sensor information is needed to perform the remote driving task; and
request the needed sensor information from the one or more surrounding vehicles.

19. The non-transitory machine-readable medium of claim 15, wherein the instructions further cause the processor to generate a world view of an environment of the vehicle.

20. The non-transitory machine-readable medium of claim 15, wherein the instructions further cause the processor to:
determine what sensor information is needed to perform the remote driving task; and
direct the one or more surrounding vehicles into a position where the supplemental sensor information can be generated.
